(19) United States
(12) Patent Application Publication
(10) Pub. No.: US 2002/0138851 A1
(43) Pub. Date: Sep. 26, 2002

(54) Methods and apparatus for simultaneously viewing multiple television programs

(75) Inventors: William P. Lord, Fishkill, NY (US); Erwin Ben Bellers, South Salem, NY (US); Kees van Zon, Peekskill, NY (US); Johan G. Janssen, Ossining, NY (US)

Correspondence Address: Philips Electronic North America Corp., 580 White Plains Road, Tarrytown, NY, 10591, US

(73) Assignee: Koninklijke Philips Electronics N.V.

(21) Appl. No.: 09/969,003

(22) Filed: Oct. 2, 2001

Related U.S. Application Data
(60) Provisional application No. 60/278,319, filed on Mar. 23, 2001.

(51) Int. Cl. H04N 7/173; H04N 7/16

(52) U.S. Cl. 725/133; 725/153

(57) ABSTRACT

Methods and apparatus for viewing a secondary television program simultaneously with a primary program. The apparatus includes a receiver for receiving a primary program and one or more secondary programs transmitted by a transmission source; a monitor adapted to display at least one of the primary program and the secondary programs; and a handheld device adapted to display at least a portion of one of the primary program and the secondary programs, wherein the program displayed on the handheld device is that which is not displayed on the monitor.

### CROSS REFERENCE TO RELATED APPLICATION

This application claims priority to the U.S. provisional patent application identified by Serial No. 60/278,319, filed on Mar. 23, 2001, the disclosure of which is incorporated by reference herein.

### FIELD OF THE INVENTION

The present invention relates generally to the field of television, and more particularly to methods and apparatus for simultaneously viewing multiple television programs.

### BACKGROUND OF THE INVENTION

For a number of years, television receivers have been equipped with picture-in-picture (PIP) capability. In PIP format, the moving, real time images of one television channel are displayed on the background of the screen and the moving, real time images of another television channel are displayed in a PIP window overlaid on a small area of the background. Because two channels are simultaneously displayed by the television receiver, two tuners are required. The viewer enters the PIP mode by pressing a PIP key of his or her controller. Then, the viewer can change either the channel of the background or the channel of the PIP by resetting the appropriate tuner. To reverse the background and PIP images, the viewer simply presses a SWAP key. To collapse the PIP window, the viewer again presses the PIP key.

Despite the prevalence of television program guides, many viewers still make their program selections by switching the television tuner from channel to channel and observing on the screen what program is being received on the respective channels. The PIP technology was an attempt to allow viewers to continue watching the current program while observing, on a small portion of the screen, the programming on the other television channels.

However, the PIP occupies a portion of the television display and, in doing so, obscures the view of the main television program. Therefore, the PIP feature can be quite distracting to each viewer that is attempting to watch the main television program. Additionally, it is not uncommon for several people to be watching the same television at the same time. One viewer may want to take advantage of the PIP feature while the other viewers do not.

Thus, a need exists for techniques which will allow a television viewer to take advantage of a PIP-like feature without taking away from the “real estate” on the current screen and without bothering other viewers that may be viewing the television.

### SUMMARY OF THE INVENTION

The present invention provides methods and apparatus for viewing a secondary television program simultaneously with a primary program. In accordance with the present invention, the secondary program is not viewed in a conventional PIP type format. Instead, either the secondary program or the primary program is viewed on a handheld device.

An advantage over the typical PIP technology is that space on the television screen is not occupied by a secondary program as in the PIP technology. In an embodiment of the present invention, the secondary program is viewed on a display window on a handheld device. Thus, other people watching the primary television program are unaffected by a person who is scanning through the rest of the channels using the secondary program display, since the scanning is actually taking place on the handheld device only. In another embodiment, the secondary program is viewed on the television while the primary program is displayed on the display window of the handheld device. In that case, every person in the room that is watching the television will be subjected to scanning through the secondary channels, since the scanning will take place on the main television rather than on the handheld unit. The person holding the handheld device will be the one who has the ability to monitor the primary program to determine, for example, the conclusion of a commercial break in the primary program.

In one aspect of the present invention, an apparatus for simultaneously viewing a primary program and one or more secondary programs is provided. The apparatus includes a handheld device adapted to receive and display at least one of a primary program signal and one or more secondary program signals, wherein the program displayed on the handheld device is that which is not displayed on a monitor.

### BRIEF DESCRIPTION OF THE DRAWINGS

For a better understanding of the invention, reference is made to the following description of exemplary embodiments, and to the accompanying drawings, wherein:

FIG. 1 is a diagram illustrating a method and apparatus for simultaneously viewing multiple television programs in accordance with the present invention;

FIG. 2 is a block diagram illustrating a processing device for use in accordance with an embodiment of the present invention;

FIG. 3 is a block diagram illustrating an illustrative embodiment of the present invention;

FIG. 4 is a block diagram illustrating another embodiment of the present invention; and

FIG. 5 is a block diagram illustrating yet another embodiment of the present invention.

### DETAILED DESCRIPTION OF THE INVENTION

The present invention provides methods and apparatus for viewing at least one secondary television program simultaneously with a primary program. As used herein the term “primary program” refers to a program that a viewer was originally viewing and the term “secondary program” refers to one or more additional programs that the viewer desires to view (e.g., a traditional PIP program). In accordance with the present invention, the secondary program is not viewed in a PIP type format. Instead, either the secondary program or the primary program is viewed on a handheld device, as will be described in detail herein.

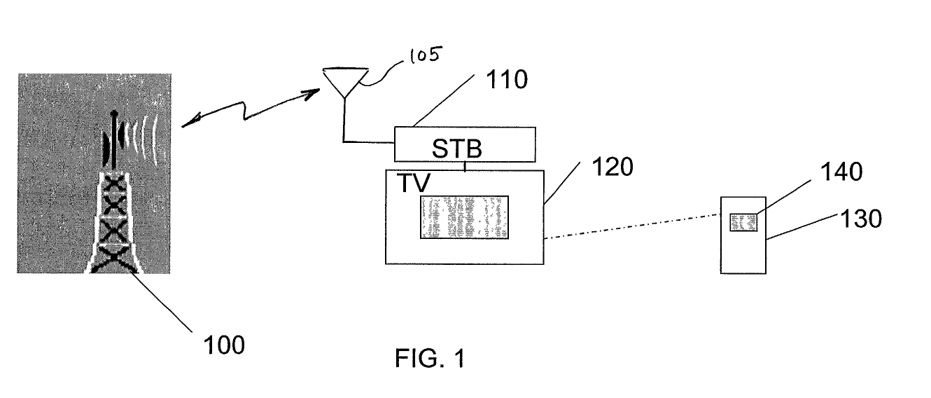

Referring initially to FIG. 1, a diagram illustrating an embodiment of the present invention is shown. The apparatus for simultaneously viewing a secondary program on a handheld device generally includes a transmission source 100 for transmitting a television program, a set top box 110, a television 120 and a handheld device 130.

Although the transmission source 100 is illustrated as a broadcast tower, the transmission source may also be a cable network, any other form of terrestrial transmission source, a satellite transmission source, a digital video disk or VHS player, the Internet, a personal computer, streaming video, or any other transmission source known to one having ordinary skill in the art. A signal from the transmission source 100 is transmitted to the set top box 110 which processes and decodes the transmitted signal and forwards the signal to the television 120. Alternatively, a processor and associated electronics may be housed within television 120 thereby eliminating the need for set top box 110.

The handheld device 130 is provided with a display window 140 for displaying either the primary or secondary television program. Although a connection is illustrated between television 120 and handheld device 120 in FIG. 1, handheld device 130 will communicate with television 120 and/or the set top box 110. A preferred communication protocol is Bluetooth. However, other communication protocols known to one having ordinary skill in the art may be utilized such as, for example, IEEE 802.11b. Additionally, in order to view a secondary program, at least one of handheld device 130, set top box 100 and television 120 contains a second tuner.

In accordance with the present invention, handheld device 130 has the ability to display video data. The display for the secondary channel may be, e.g., a small sized, low resolution, three to five frames per second, black and white video display, full color streaming video display, or any other display suitable for providing the handheld device display functions described herein. In the former (black and white) embodiment, the second tuner does a frame grab on the content that it is tuned to, at a specified frequency (e.g., every three to five seconds). Optionally, the frames are converted to the resolution of the handheld device. The resulting image is then converted to a format required by the handheld device (possibly including compression). The image is then sent (typically via radio frequency (RF) in accordance with the above-noted Bluetooth or 802.11b protocols) to the handheld device.

An advantage over the typical PIP technology is that space on the television screen is not occupied by a secondary program as in the PIP technology. In an embodiment of the present invention, the secondary program is viewed on display window 140 on the handheld device 130. Thus, other people watching the primary television program are unaffected by a person who is scanning through the rest of the channels, since the scanning is actually taking place on the handheld device only. In another embodiment, the secondary program is viewed on the television 120 while the primary program is displayed on the display window 140 of handheld device 130. In that case, every person in the room that is watching the television will be subjected to scanning through the secondary channels, since the scanning will take place on the main television rather than on the handheld unit. The person holding the handheld device will be the one who has the ability to monitor the primary program to determine, for example, the conclusion of a commercial break in the primary program. It is contemplated that the handheld device is capable of controlling the television and/or set top box.

Handheld device 130 may be a remote control device associated with video and audio applications(such as, for example, the Pronto manufactured and sold by Philips Electronics), a personal digital assistant (PDA), a handheld computer (such as, for example, a Webpad, Zaptop or Sony Airboard), or any device having a processor and associated memory.

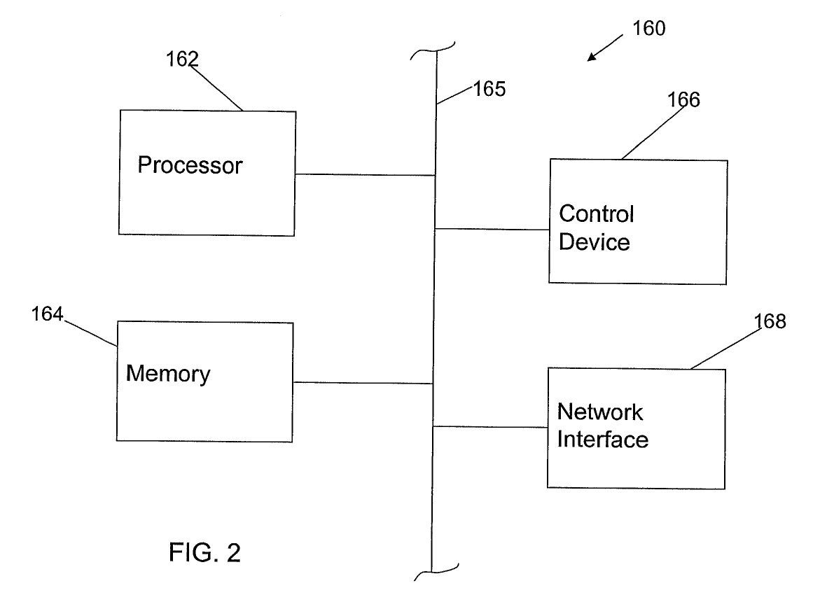

FIG. 2 shows an example of a processing device 160 that may be used to implement, e.g., a program for executing the simultaneous viewing of a secondary television program described above with reference to FIG. 1. The device 160 includes a processor 162 and a memory 164 which communicate over at least a portion of a set 165 of one or more system buses. Also utilizing at least a portion of the set 165 of system buses are a control device 166 and a network interface device 168. The device 160 may represent, e.g., portions or combinations of one or more of the television 120, handheld device 130, set top box 110, a desktop computer or any other type of processing device for use in implementing at least a portion of a simultaneous viewing process in accordance with the present invention. The elements of the device 160 may correspond to conventional elements of such devices.

For example, the processor 162 may represent a microprocessor, central processing unit (CPU), digital signal processor (DSP), or application-specific integrated circuit (ASIC), as well as portions or combinations of these and other processing devices. The memory 164 is typically an electronic memory, but may comprise or include other types of storage devices, such as disk-based optical or magnetic memory. The control device 166 may be associated with the processor 162. The control device 166 may be further configured to transmit control signals.

The simultaneous viewing techniques described herein may be implemented in whole or in part using software stored and executed using the respective memory and processor elements of the device 160. For example, the simultaneous viewing of two television programs may be implemented at least in part using one or more software programs stored in memory 164 and executed by processor 162. The particular manner in which such software programs may be stored and executed in device elements such as memory 164 and processor 162 is well understood in the art and therefore not described in detail herein.

It should be noted that the device 160 may include other elements not shown, or other types and arrangements of elements capable of providing the simultaneous viewing functions described herein. A given one of the processing elements of FIG. 1, e.g., the handheld device, may be implemented using only a subset of the elements of FIG. 2, e.g., the processor 162 and memory 164.

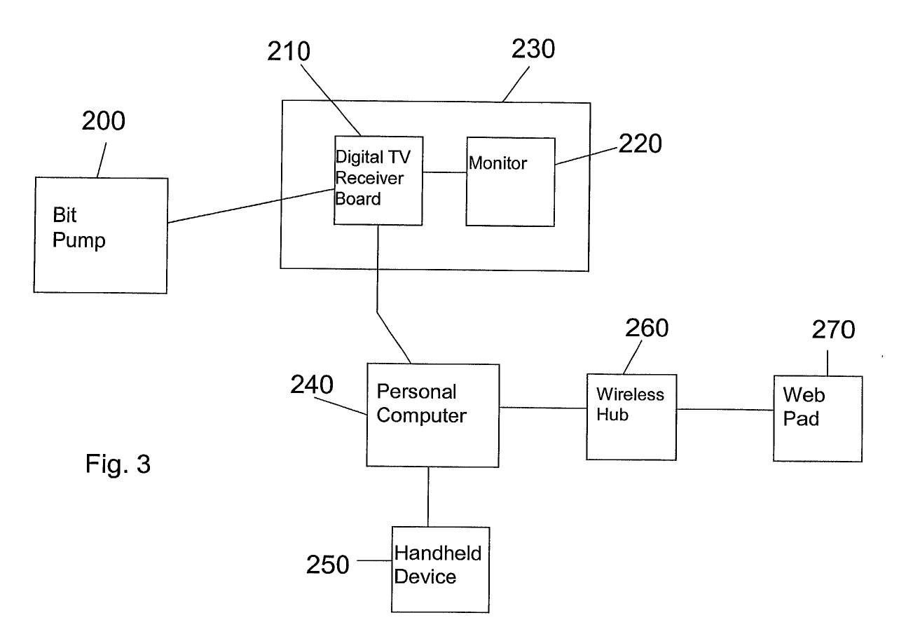

Referring now to FIG. 3, an illustrative embodiment of an apparatus for simultaneously viewing a primary and one or more secondary television programs is illustrated. The apparatus includes bit pump 200, digital television receiver board 210, monitor 220, personal computer 240, PDA 250, wireless hub 260 and web pad 270.

Bit pump 200 is the transmission source which transmits the video and audio data to the digital television receiver board 210. The channel transmission rate of bit pump 200 is 19.2 megabytes per second. Bit pump 200 sends a signal at four times the standard definition television channels.

The digital television receiver board 210 receives a signal from bit pump 200 and processes that signal. Digital television receiver board 210 preferably includes at least two decoders, e.g., a software decoder and a hardware decoder, two hardware decoders, etc. The second decoder monitors the secondary channels (those that the viewer is not viewing as its primary channel) and performs several tasks. The tasks are primarily directed to reformatting the data for an intended display, and include a frame grab, scaling and color or gray scale mapping. This data is then transmitted to handheld device 250. The hardware decoder is configured to decode a signal associated with the primary channel being viewed by the viewer. Once that signal is decoded, it too is transmitted to monitor 220. Monitor 220 may also have the ability to receive a signal directly from digital television receiver board 210 without the signal being decoded. It is contemplated that the digital television receiver board 210 and monitor 220 may be combined within a single housing 230. It is also contemplated that receiver board 210 may be analog rather than digital.

In one embodiment of the present invention, the digital television receiver board 210 is connected to a personal computer 240 via, for example, an Ethernet connection. Personal computer 240 may be any other device having a processor and associated memory, e.g., may correspond to processing device 160 of FIG. 2. Personal computer 240 is then connected to a handheld device 250, such as a remote control device associated with video and audio applications, a personal digital assistant (PDA), (such as the Pronto manufactured and sold by Philips Electronics), or any other device having a processor and associated memory. The connection between the personal computer 240 and PDA 250 may be an RS 232 serial connection and is preferably a wireless connection. Alternatively, the PDA 250 may communicate with personal computer 240 via infrared light.

In another embodiment of the present invention, the personal computer 240 may be eliminated and the digital television receiver board 210 will communicate directly with PDA 250 via a cable or a wireless connection. In this scenario, the control signal will originate at the PDA. The video data may originate at either one of the PDA 250 or the digital television receiver board 210.

In yet another embodiment of the present invention, the personal computer 240 communicates through wireless hub 260 to a web pad 270.

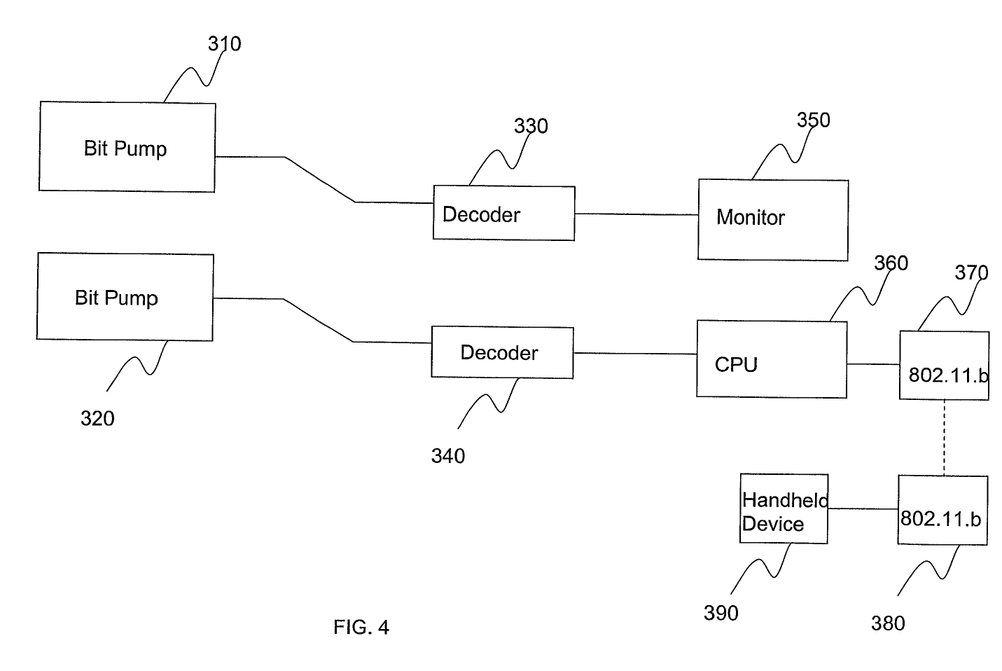

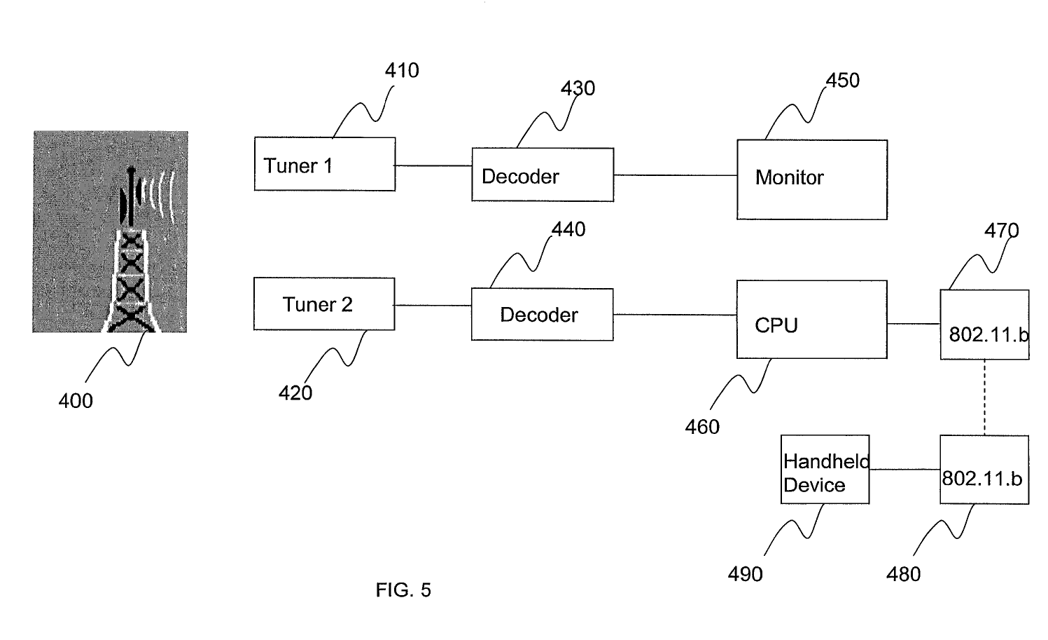

FIGS. 4 and 5 are block diagrams illustrating two additional embodiments of the present invention. Referring initially to FIG. 4, a pair of transmission sources 310 and 320, illustrated as bit pumps, each transmits a signal to a pair of decoders 330 and 340, respectively. Decoder 330 decodes and forwards the signal to monitor 350. Decoder 340 may be required to perform an additional scaling function with regard to the signal to ensure that the signal is formatted properly for display on the handheld device 390. The central processing unit (CPU) 360 processes the signal from decoder 340 and transmits the signal over a wireless hub using an 802.11b communication protocol to handheld device 390. CPU 360 may also be a digital signal processor (DSP) or an application specific integrated circuit (ASIC).

Referring now to FIG. 5, a transmission source 400, illustrated as a broadcast tower, transmits signals representative of each of the channels on a television set, to a pair of tuners 410 and 420. Tuners 410 and 420, in turn, transmit the signal to decoders 430 and 440, respectively. Decoder 430 decodes and forwards the signal to monitor 450. Decoder 440 is required to perform an additional scaling function with regard to the signal to ensure that the signal is formatted properly for display on the handheld device 490. The central processing unit (CPU) 460 processes the signal from decoder 440 and transmits the signal over a wireless hub using an 802.11b communication protocol to handheld device 490. CPU 460 may also be a digital signal processor (DSP) or an application specific integrated circuit (ASIC).

Although the illustrative embodiments of the present invention have been described herein with reference to the accompanying drawings, it is to be understood that the invention is not limited to those precise embodiments, and that various other changes and modifications may be affected therein by one having ordinary skill in the art without departing from the scope or spirit of the invention. All such changes and modifications are intended to be included within the scope of the invention as defined by the appended claims.

What is claimed is:

1. An apparatus for simultaneously viewing one or more secondary programs along with a primary program, at least a selected one of the secondary and primary programs being displayable on a monitor associated with the apparatus, the apparatus comprising:
a handheld device having a processor coupled to a memory, the device being adapted to receive and display at least a portion of at least one of a primary program and one or more secondary programs, wherein the program displayed on the handheld device is that which is not displayed on the monitor.

2. The apparatus for simultaneously viewing one or more secondary programs along with a primary program as recited in claim 1 wherein the handheld device comprises a personal digital assistant.

3. The apparatus for simultaneously viewing one or more secondary programs along with a primary program as recited in claim 1 further comprising a receiver for receiving a signal from a transmission source.

4. The apparatus for simultaneously viewing one or more secondary programs along with a primary program as recited in claim 3 wherein the transmission source comprises a broadcast source.

5. The apparatus for simultaneously viewing one or more secondary programs along with a primary program as recited in claim 3 wherein communication protocol between the handheld device and the receiver is at least one of Bluetooth and 802.11b.

6. The apparatus for simultaneously viewing one or more secondary programs along with a primary program as recited in claim 3 wherein the transmission source is a bit pump.

7. The apparatus for simultaneously viewing one or more secondary programs along with a primary program as recited in claim 6 wherein the bit pump transmits a digital signal.

8. The apparatus for simultaneously viewing one or more secondary programs along with a primary program as recited in claim 3 wherein the receiver is a digital television receiver board.

9. The apparatus for simultaneously viewing one or more secondary programs along with a primary program as recited in claim 8 wherein the digital television receiver board includes a software decoder for monitoring the secondary programs and a hardware decoder for decoding the primary signal.

10. The apparatus for simultaneously viewing one or more secondary programs along with a primary program as recited in claim 1 wherein the monitor is a television.

11. The apparatus for simultaneously viewing one or more secondary programs along with a primary program as recited in claim 1 wherein the handheld device includes a display window for displaying one of the primary program and the secondary programs.

12. The apparatus for simultaneously viewing one or more secondary programs along with a primary program as recited in claim 1 wherein the handheld device includes remote control capability of the monitor.

13. The apparatus for simultaneously viewing one or more secondary programs along with a primary program as recited in claim 1 further comprising a personal computer for processing a signal from the handheld device.

14. The apparatus for simultaneously viewing one or more secondary programs along with a primary program as recited in claim 1 wherein the handheld device is a handheld computer.

15. The apparatus for simultaneously viewing one or more secondary programs along with a primary program as recited in claim 1 further comprising a wireless hub for communicating a signal from the web pad.

16. The apparatus for simultaneously viewing one or more secondary programs along with a primary program as recited in claim 1 wherein the portion displayed on the handheld device comprises a sequence of one or more selected frames.

17. The apparatus for simultaneously viewing one or more secondary programs along with a primary program as recited in claim 16 wherein the selected frames are periodically updated.

18. The apparatus for simultaneously viewing one or more secondary programs along with a primary program as recited in claim 1 wherein the portion displayed on the handheld device has a lower resolution than the resolution of the program which is displayed on the monitor.

19. A method of simultaneously viewing a primary program and one or more secondary programs comprising the steps of:
receiving a primary program and one or more secondary programs transmitted by a transmission source;
displaying at least one of the primary program and the secondary programs on a monitor; and
displaying one of the primary program and the secondary programs on a handheld device, wherein the program displayed on the handheld device is that which is not displayed on the monitor.

20. An apparatus for simultaneously viewing a primary program and one or more secondary programs, the apparatus comprising:
a receiver for receiving a primary program and one or more secondary programs transmitted by a transmission source;
a monitor adapted to display at least one of the primary program and the secondary programs; and
a handheld device adapted to display at least a portion of one of the primary program and the secondary programs, wherein the program displayed on the handheld device is that which is not displayed on the monitor.
